(19) United States
(12) Patent Application Publication
(10) Pub. No.: US 2010/0058994 A1
(43) Pub. Date: Mar. 11, 2010

(54) PET TOY WITH CAPTIVE CHASE BALL

(75) Inventor: TIBOR SIKLOSI, JOPLIN, MO (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: BERGAN, LLC, Monkey Island, OK (US)

(21) Appl. No.: 12/391,554

(22) Filed: Feb. 24, 2009

Related U.S. Application Data
(60) Provisional application No. 61/095,400, filed on Sep. 9, 2008.

(51) Int. Cl. A01K 29/00

(52) U.S. Cl. 119/707

(57) ABSTRACT

A reconfigurable animal toy is disclosed herein. The toy has a plurality of connectable track pieces that may be assembled to define a track for receiving a captive ball. The track allows an animal to touch the ball for selectively propelling the ball along the track. To enhance the interest of the animal, the track may define a randomizer for affecting travel of the ball and may define a sight line interference member. Additional features of the animal toy may include scratch pads and visual devices to enhance and maintain the interest of the animal.

### CROSS REFERENCE TO RELATED APPLICATIONS

This application claims the benefit of prior filed U.S. Provisional Patent Application No. 61/095,400 entitled “PET TOY WITH CAPTIVE CHASE BALL,” filed Sep. 9, 2008, the contents of which are hereby incorporated by reference.

### FIELD OF THE INVENTION

The invention relates to an animal amusement device. In particular, the invention relates to a configurable track assembly that defines a track for a captive ball that may be propelled by striking with an animal paw.

### BACKGROUND OF THE INVENTION

Sources indicate that the number of households having pets is increasing. Many families have indoor pets, such as dogs or cats. Playing with a pet is essential for bonding, weight control, and for helping the pet develop muscle tone, agility, and stamina. Therefore, particularly with cats, but with other animals as well, toys designed to facilitate interaction with pets are desirable.

Many pet toys offer only limited utility, which may result in the pet becoming bored or disinterested in the device. Therefore, it is desirable for a pet toy to offer different challenges and to be reconfigurable to present the animal with novel stimuli.

### SUMMARY OF THE INVENTION

A reconfigurable animal toy is disclosed that has a plurality of connectable track pieces that may be assembled to define a track for receiving a captive ball. The track allows an animal to touch the ball for selectively propelling the ball along the track. In one embodiment, the track may be assembled to form a continuous loop, e.g., circular or figure 8 shaped.

In one embodiment, the continuous track defines a randomizer for affecting travel of the ball. The randomizer may be a raised portion of the track or may be an obstacle, such as a movable lever or other type of obstacle.

In another embodiment, the continuous track defines a sight line interference member. The sight line interference member may be a raised portion of the track. Alternatively, the sight line interference member may be a covered portion of the track.

The connectable track pieces may define a receptacle sized to receive an insert for securing the track pieces in an end to end configuration. In another embodiment, the connectable track pieces have an integral connection mechanism. One example of an integral connection mechanism includes a retaining surface on a first side of a first one of the track pieces and on a first side of a second one of the track pieces. The integral connection mechanism has a vertical securement post extending from a second side of the first one of the track pieces and extending from a second side of the second one of the track pieces. The vertical securement post on the first one of the track pieces is received behind the retaining surface on the second one of the track pieces. A vertical securement pin on the second one of the track pieces is received behind the retaining surface on the first one of the track pieces for securing the pieces to one another.

It may be desirable to include additional features with the animal toy including visual devices to enhance and maintain the interest of the animal.

### BRIEF DESCRIPTION OF THE DRAWINGS

FIG. 1 is a perspective view of a pet toy of the present disclosure.

FIG. 2 is a perspective view of the underside of the toy of the present disclosure.

FIG. 3 is a perspective view of the ends of two circular pieces joined by an insert.

FIG. 4 is a perspective view of a straight piece of the toy of the present disclosure.

FIG. 5 is a perspective view of an insert of the toy of the present disclosure.

FIG. 6 is a perspective view of an alternate embodiment of a track piece having an integral mechanism for securing adjacent pieces to one another.

FIG. 7 is a perspective view of a section of track having a sight line interference member or tunnel piece affixed thereto.

### DETAILED DESCRIPTION OF THE PREFERRED EMBODIMENTS

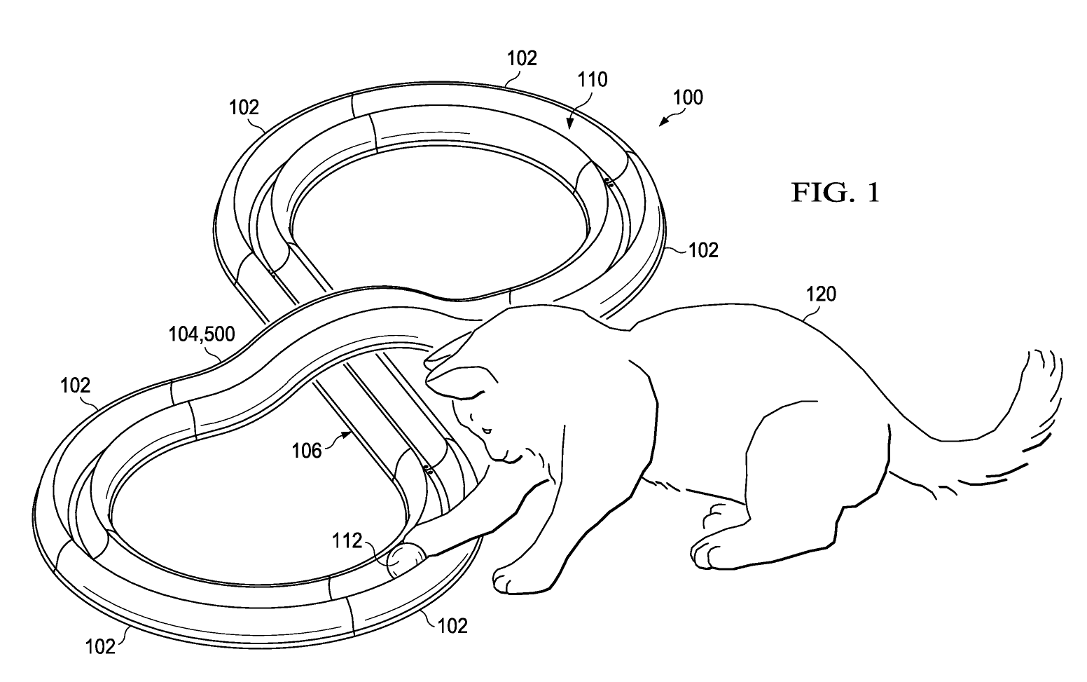

Referring now to FIG. 1, a perspective view of a pet toy 100 according to aspects of the present disclosure is shown. In one embodiment, the toy 100 comprises a number of interconnectable pieces that may be assembled by a user in various configurations. In FIG. 1, toy 100 is configured in a “figure 8” shape, although it will be appreciated that many other combinations are possible. Furthermore, the various configurations may be altered and re-assembled by a user as will be described in greater detail below.

In the present embodiment, toy 100 includes one or more curved pieces 102. The radius of curvature of pieces 102 may vary as may the overall size of toy 100. It can be seen that in the present embodiment, four curved pieces 102 could be used to form a circular configuration. However, in FIG. 1, six curved pieces 102 have been joined with a bridge piece 104 and a straight piece 106. This forms the FIG. 8 design of the present embodiment. When pieces 102, 104, 106 are assembled, as shown in FIG. 1, it can be seen that a channel or track 110 is defined continuously along the figure 8 path. A ball 112 is held captive in the track such that the ball 112 may roll freely around the track but may not easily be removed, particularly by pet 120. Although pet 120 of FIG. 1 is a cat, it will be appreciated that other household or outdoor pets may use toy 100. Bridge piece 104 functions as a sight line interference member 500 and also as a randomizer that affects travel of ball 112 around the track. Depending upon the force with which ball 112 is struck by pet 120, ball 112 may travel over bridge piece 104 or may reverse direction. Therefore, bridge piece 104 functions to randomize the travel direction of ball 112, thereby enhancing the interest of pet 112 in interacting with toy 100.

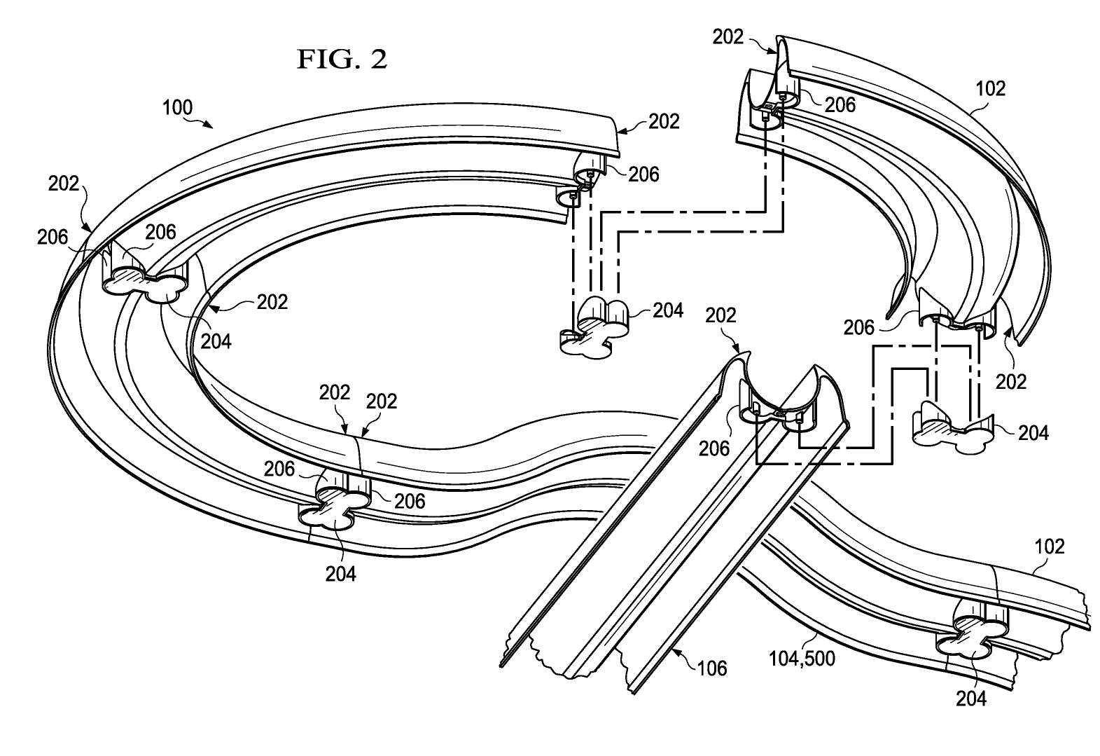

Referring now to FIG. 2, a perspective view of the underside of toy 100 is shown. Here, only a portion of the figure 8 configuration is shown in order to illustrate one embodiment of a means of interconnecting the various pieces of toy 100. Here again, it can be seen that a number of curved pieces 102 have been joined with a bridge piece 104 and a straight piece 106.

In FIG. 2, it can be seen that ends 202 of the various pieces may be joined together by a number of inserts 204 interfitted into a number of receptacles 206 defined in the ends 202 of the pieces. In the present embodiment, each piece, whether a curved piece 102, a bridge piece 104, or a straight piece 106, preferably join together in the same manner. In the present embodiment, ends 202 are substantially similar such that when joined together the joined ends 202 form a part of the continuous track 110. The receptacles 206 may be defined in the pieces themselves. The receptacles 206 may have a cooperating relationship with the inserts 204 such that the inserts 204 provide a friction fit in the receptacles 206. The insert 204 will be sized and shaped to securely hold the ends 202 together.

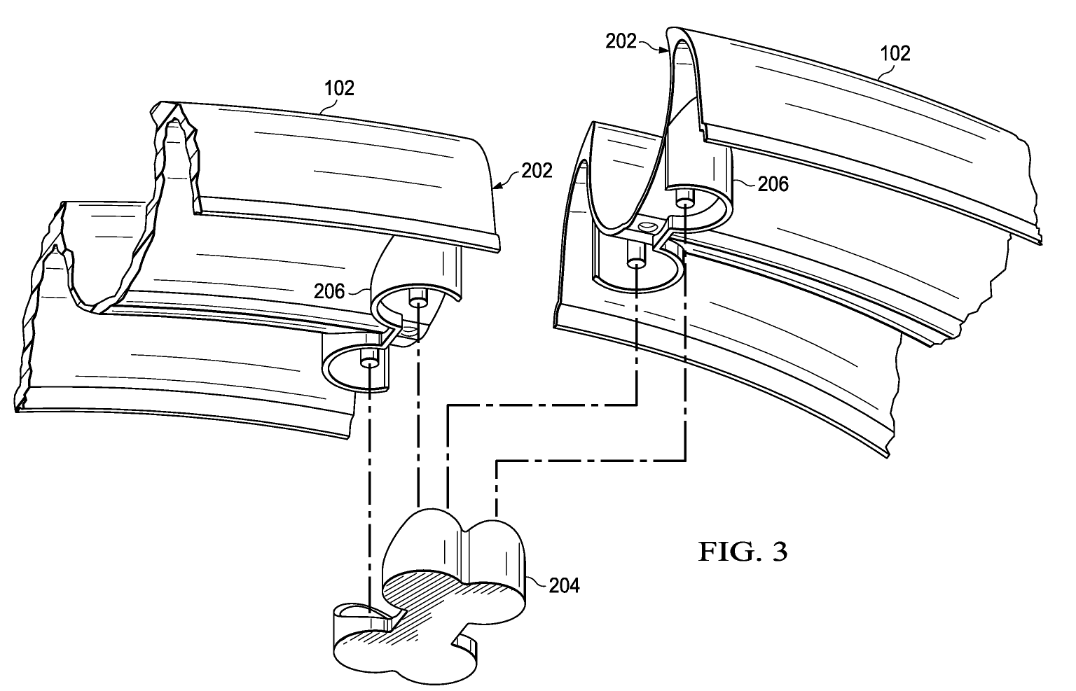

Referring now to FIG. 3, a perspective view of ends 202 of two circular pieces 102 joined by an insert 204 is shown. From this viewpoint, receptacles 206, defined by the pieces 102, can clearly be seen. In one embodiment, pieces 102, 104, 106 of toy 100 will be constructed by a molding technique. In such embodiments, receptacles 206 may form a part of the mold such that each piece is a unitary construction. It can further be seen in receptacles 206 that protrusions may be defined that interfit and further secure insert 204 in receptacles 206. A number of holes or openings may be defined near receptacles 206 in order to ease removal of insert 204 from receptacles 206. This may facilitate disassembly or reconfiguration of toy 100.

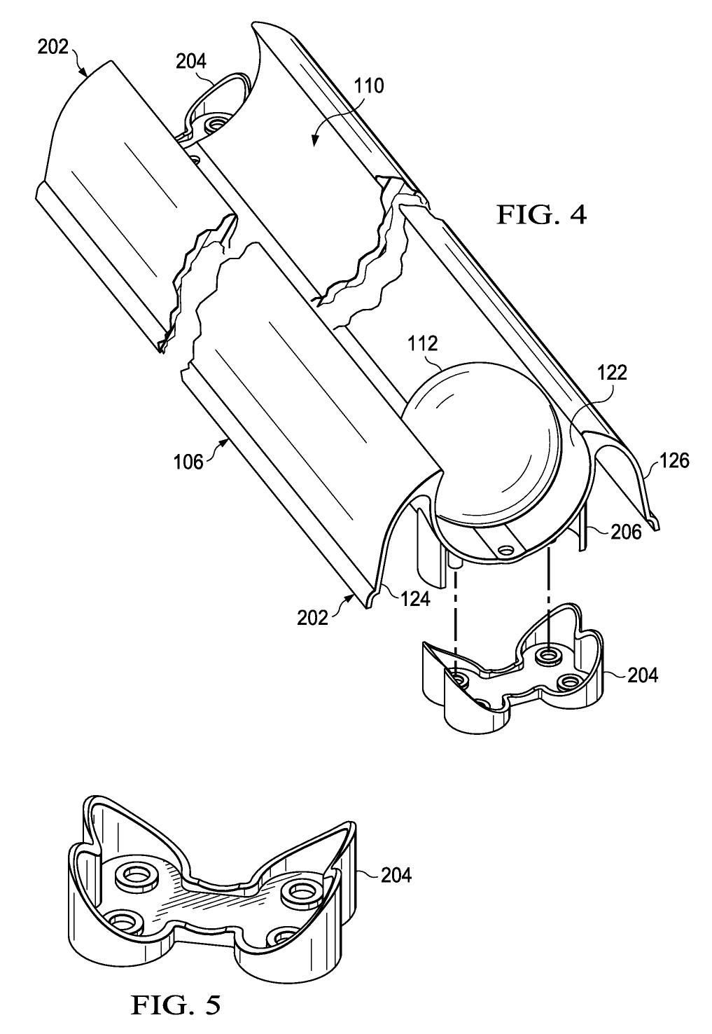

Referring now to FIG. 4, a perspective view of a straight piece 106 is shown. Here, the overall shape of straight piece 106 that retains ball 112 can be seen. It will be appreciated that straight piece 106, as well as the other pieces of toy 100 will be shaped so as to define channel 110 with a channel defining surface 122 that allows the ball 112 to roll freely along channel 110 but does not allow the ball to be easily lifted out of the channel, i.e., channel defining surface 122 of channel 110 “captures” ball 112. Pieces 102, 104, 106 further define a first exterior support wall 124 and a second exterior support wall 126. Ball 112 may be plastic, rubber, or another suitable material. In some embodiments, pieces 102, 104, 106 will be molded from a pliable, resilient material such that ball 112 can be inserted or removed from channel 110 by a human but will not be easily removed by an animal. Ends 202 of straight piece 106 can be seen to define a receptacle 206. One end 202 is shown with an attached insert 204.

Referring now to FIG. 5, a perspective view of an insert 204 is shown. From the viewpoint of FIG. 5, it can be seen that the shape of the insert 204 may be defined to interfit with the various shapes and features of the receptacles 206 defined in the various pieces of the toy 100. This would include suitable contours and molding to interfit securely with the receptacles 206 so as to hold the various track pieces together.

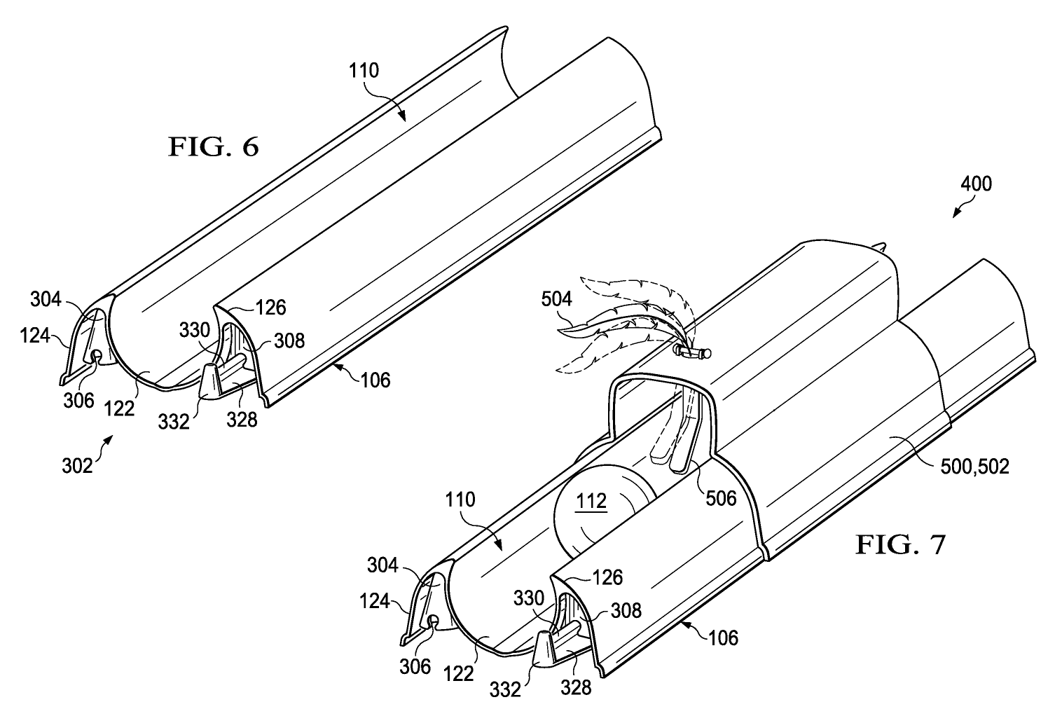

Referring now to FIG. 6, a perspective view of end 302 of track piece 106 is shown wherein end 302 is provided with an alternate, integral configuration for affixing adjacent pieces 106 to other pieces 102, 104, 106. Although piece 106 is shown for purposes of example, it should be understood that any of pieces 102, 104, 106 could be shown, as each piece having the alternate, integral configuration will be provided with identical structure. End 302 has a receiving surface 304 that spans between first exterior support wall 124 and channel defining surface 122. Receiving surface 304 defines receptacle 306.

End 302 further has a retaining surface 308 that spans between second exterior support wall 126 and channel defining surface 122. A horizontal member 328 extends outward from retaining surface 308. Horizontal member 328 and defines a key member 330 that spans between retaining surface 308 and vertical securement post 332.

During assembly of adjacent pieces 102, 104, 106 having an integral configuration, i.e., having ends 302, vertical securement post 332 on a first piece 102, 104, 106 is placed behind receiving surface 304 of second piece 102, 104, 106. Simultaneously, vertical section post 332 on second piece 102, 104, 106 is placed behind receiving surface 304 of first piece 102, 104, 106. Pressure is applied to snap connect adjacent pieces 102, 104, 106 by snapping key member 330 on first piece 102, 104, 106 into receptacle 306 on second piece 102, 104, 106 and by snapping key member 330 on second piece 102, 104, 106 into receptacle 306 on first piece 102, 104, 106.

In addition to the embodiments described above, additional embodiments may provide lengths of track 102, 104, 106 having a sight line interference member 500 (FIGS. 1, 7). One example of sight line interference member 500 is a tunnel 502 (FIG. 7) or cavern for receiving ball 112. In some embodiments, sight line interference will be achieved by attaching a top part or cover or sight line interference member 500 to a regular track piece 102, 104, 106, as shown with tunnel piece 502 of FIG. 7. A feather, toy, or other visual device 504 that may be interesting to a pet may be contained within the tunnel piece 502 or attached to tunnel piece 502, e.g., with a string or lever 506, such that visual device 502, e.g., feather, is moved or agitated when struck by traveling ball 112. An obstacle, such as lever 506, may also serve as a randomizer by providing a resistance to travel of ball 112, which may be sufficient to halt movement of ball 112. In another embodiment, sight line interference member 500 may be a bridge piece 104 (FIGS. 1, 2). Various forms of sight line interference members may be provided that function to obstruct a view of ball 112 from the vantage point of pet 120 as ball 112 travels around channel 110.

Additional pieces may also increase the number and type of configurations into which the tracks can be arranged. For example, the tracks may be arranged with various combinations of straight and or curved pieces with stoppers at each end. In this way, the track need not be continuous but a stopper may be used to prevent the ball from escaping the track. Additionally, elevation pieces may serve to lift parts of the track off of a support surface. Inclined pieces may interpose track sections at varying levels to allow gravity to move the ball.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A reconfigurable animal toy comprising:
a plurality of connectable track pieces that may be assembled to define a track for receiving a captive ball, said track allowing an animal to touch said ball for selectively propelling said ball along said track.

2. The animal toy according to claim 1 wherein:
said track is a continuous loop.

3. The animal toy of claim 1 wherein:
said track defines a randomizer for affecting travel of said ball.

4. The animal toy of claim 3 wherein:
said randomizer is a raised portion of said track.

5. The animal toy of claim 3 wherein:
said randomizer is an obstacle.

6. The animal toy of claim 1 further comprising:
said track defines a sight line interference member for obstructing a view of said ball by said animal.

7. The animal toy of claim 6 wherein:
said sight line interference member is a raised portion of said track.

8. The animal toy of claim 6 wherein:
said sight line interference member is a covered portion of said track.

9. The animal toy of claim 1 wherein:
said connectable track pieces define a receptacle sized to receive an insert, said insert for securing said track pieces in an end to end configuration.

10. The animal toy of claim 1 wherein:
said connectable track pieces have an integral connection mechanism.

11. The animal toy of claim 10 wherein:
said integral connection mechanism has a retaining surface on a first side of a first one of said track pieces and on a first side of a second one of said track pieces;
said integral connection mechanism having a vertical securement post extending from a second side of said first one of said track pieces and extending from a second one side of said second one of said track pieces;
wherein said vertical securement post on said first one of said track pieces is received behind said retaining surface on said second one of said track pieces and said vertical securement post on said second one of said track pieces is received behind said retaining surface on said first one of said track pieces for securing said first one of said track pieces to said second one of said track pieces.

12. The animal toy of claim 11 wherein:
said retaining surface on said first one of said track pieces defines a first receptacle;
said retaining surface on said second one of said track pieces defines a second receptacle;
said first one of said track pieces further defines a key member for being received in said second receptacle;
said second one of said track pieces further defines a key member for being received in said first receptacle.

13. The animal toy of claim 1 wherein:
said connectable track pieces are configured to define an enclosed space on at least a portion of the toy.

14. The animal toy of claim 1 wherein:
said connectable track pieces are configured to define an open top track on at least a portion of the toy.
